(19) United States
(12) Patent Application Publication
(10) Pub. No.: US 2019/0205354 A1
(43) Pub. Date: Jul. 4, 2019

(54) HAIRDRESSING ON-DEMAND SERVICES INTERFACE

(71) Applicant: DILLON JAMES KORPMAN, NASHVILLE, TN (US)

(72) Inventor: DILLON JAMES KORPMAN, NASHVILLE, TN (US)

(21) Appl. No.: 16/234,279

(22) Filed: Dec. 27, 2018

Related U.S. Application Data
(60) Provisional application No. 62/610,552, filed on Dec. 27, 2017.

(51) Int. Cl. G06F 16/9537; H04W 4/029; G06Q 10/02

(52) U.S. Cl. CPC G06F 16/9537; G06Q 10/02; H04W 4/029

(57) ABSTRACT

An interactive environment for enabling a user to request on-demand hairdressing services using a mobile computing device. In particular, mobile computing devices, such as smart phones, tablet computers, and similar GPS-equipped cellular telephone devices, are used in connection with an on-demand service that enables the user to locate and request hairdressing services on demand or in real-time using a simplified user interface schematic. Functionality, including but to limited to, the location of available service providers, the types of service available, the estimated fees and other information, can be aggregated and provided to the user in an efficient and user-friendly manner. The information provided and types of service options available can be location-specific or region-specific.

This application claims benefit of and priority to U.S. Provisional Application No. 62/610,552, filed Dec. 27, 2017, which is incorporated herein by specific reference for all purposes.

### FIELD OF INVENTION

This invention relates to an system and interface for providing and obtaining on-demand hairdressing personal activities by a user of a mobile computing device.

### SUMMARY OF INVENTION

In various exemplary embodiments, the present invention comprises an interactive environment for enabling a user to request on-demand hairdressing services (from a hairdresser, stylist, barber, or the like) using a mobile computing device. In particular, some embodiments described herein enable mobile computing devices, such as smart phones, tablet computers, and similar GPS-equipped cellular telephone devices, to be used in connection with an on-demand service that enables the user to locate and request hairdressing services on demand or in real-time using a simplified user interface schematic. Functionality, including but to limited to, the location of available service providers, the types of service available, the estimated fees and other information, can be aggregated and provided to the user in an efficient and user-friendly manner. The information provided and types of service options available can be location-specific or region-specific.

In several embodiments, different user interface features are provided, in whole or in part, by an application or program that is stored and operated on the user's mobile computing device. The application can be configured to communicate with an on-demand hairdressing service system that arranges services between users and hairdressers. For example, a user can request a haircut, the system can determine available hairdressers that meet the parameters of the user's request, and arrange for the user to meet with a particular hairdresser to perform the service. The user interacts with the user interface features to make different selections for viewing specified information and requesting on-demand service options.

### BRIEF DESCRIPTION OF THE DRAWINGS

FIG. 1 show a diagram of the system in accordance with an embodiment of the present invention.

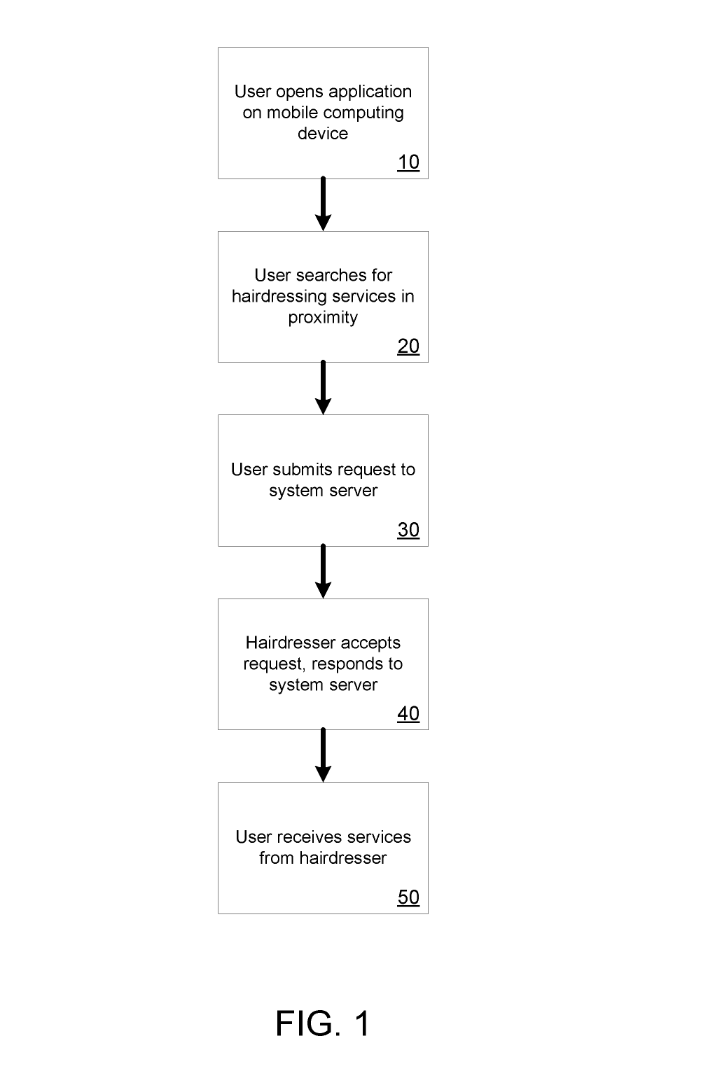

### DETAILED DESCRIPTION OF EXEMPLARY EMBODIMENTS

In various exemplary embodiments, the present invention comprises an interactive environment for enabling a user to request on-demand hairdressing services (from a hairdresser, stylist, barber, or the like) by opening an application 10 using a mobile computing device. In particular, some embodiments described herein enable mobile computing devices, such as smart phones, tablet computers, and similar GPS-equipped cellular telephone devices, to be used in connection with an on-demand service that enables the user to search for 20, locate and request 30 hairdressing services on demand or in real-time using a simplified user interface schematic. Functionality, including but to limited to, the location of available service providers, the types of service available, the estimated fees and other information, can be aggregated and provided to the user in an efficient and user-friendly manner. The information provided and types of service options available can be location-specific or region-specific.

In several embodiments, different user interface features are provided, in whole or in part, by an application or program that is stored and operated on the user's mobile computing device. The application can be configured to communicate with an on-demand hairdressing service system that arranges services between users and hairdressers. For example, a user can request a haircut, the system can determine available hairdressers that meet the parameters of the user's request, and arrange for the user to meet with a particular hairdresser to perform the service. The user interacts with the user interface features to make different selections for viewing specified information and requesting on-demand service options.

The location of the mobile computing device is automatically determined so that user interface features for requesting an on-demand service can be presented on the device's display using the device's real-time location. Locations of hairdressers in the area (in some embodiments, using a set or pre-established distance parameter or threshold) are displayed in a list or on a map. The user can then interact with the display to find out additional information about selected hairdressers, including, but not limited to, next availability, fees and costs, availability of parking, distance, travel time, user ratings, and the like.

Once the user makes a decision in requesting a particular service provider, the user confirms the service request. The computing device then provides the service request to the on-demand service system 30 with user information to arrange the service between the user and the desired service provider. The service provider may or may not accept the request, or may make a counter-proposal, by responding to the system server 40.

After confirmation/acceptances from both the user and the service provider, in one exemplary embodiment the user proceeds to the service provider's location to receive the hairdressing service 50. The system thus provides the benefit of on-demand hairdressing services by conveniently located stylists without lines for the user. The stylist has the benefit of being able to fill un-taken time slots in his or her schedule, and provide services without having to move any of their equipment. In a “premium” version of the present invention, the stylist is mobile, and goes to the user's location to provide hairdressing services.

After services are provided, the system prompts the user to provide a ranking for the service provider. Rankings can be provided in a variety of forms, and are available to users through the mobile device application when considering potential service providers.

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of coordinating hairdressing services, comprising the steps of:
receiving, from an application program operating on a user mobile computing device, a search request for hairdressing services within a selected distance from the location of the user mobile computing device at the time of the request, as determined by a GPS device in the user mobile computing device;
performing a search in a system database for registered providers of hairdressing services with a home location within the selected distance from the location of the user mobile computing device;
transmitting the search results to the user mobile computing device;
receiving, from the user application program, a request for hairdressing services for a particular provider;
transmitting the request for services to the particular provider;
receiving, from a second application program operating on a provider mobile computing device, a response to the request for services; and
transmitting the response to the user application program.
